(19) United States
(12) Patent Application Publication
(10) Pub. No.: US 2013/0169618 A1
(43) Pub. Date: Jul. 4, 2013

(54) LIQUID CRYSTAL DISPLAY DEVICE

(71) Applicant: Panasonic Liquid Crystal Display Co., Ltd., Hyogo (JP)

(72) Inventors: Takahiro Kobayashi, Osaka (JP); Yoshio Umeda, Hyogo (JP)

(73) Assignee: Panasonic Liquid Crystal Display Co., Ltd., Hyogo (JP)

(21) Appl. No.: 13/730,004

(22) Filed: Dec. 28, 2012

(30) Foreign Application Priority Data
Dec. 28, 2011 (JP) 2011-288297

(51) Int. Cl. G09G 5/10

(52) U.S. Cl. CPC G09G 5/10; G09G 3/36
USPC 345/212; 345/87

(57) ABSTRACT

A liquid crystal display device includes: a liquid crystal display unit that includes pixels and displays an image based on an input image signal input for each of frames; a drive unit that applies a voltage based on the input image signal to the pixels of the liquid crystal display unit while inverting a polarity of the voltage for each of the frames; a signal discrimination unit that discriminates whether the input image signal is an interlaced signal; and a signal generation unit that generates a phase inversion enabling signal for inverting a phase of the polarity of the voltage applied to the pixels, in a case where the signal discrimination unit discriminates that the input image signal is the interlaced signal. The drive unit inverts the phase of the polarity of the voltage applied to the pixels when the signal generation unit generates the phase inversion enabling signal.

### BACKGROUND

1. Technical Field

This disclosure relates to a liquid crystal display device that displays an image on a liquid crystal display unit.

2. Description of the Related Art

It is known that, in a liquid crystal display unit, when a direct-current (DC) driving voltage is applied to pixels in order to drive the pixels including liquid crystal, the liquid crystal is deteriorated and the life of the liquid crystal is reduced and, as a result, display quality is deteriorated. Therefore, in general, alternate-current (AC) voltage driving for inverting, for each of frames, the polarity of a voltage applied to the pixels is performed in the liquid crystal display unit. Further, in AC voltage driving of a dot inversion type for example, the polarity of a voltage applied to pixels of red (r), green (g), and blue (b), which are adjacent to one another, for each of frames is alternately inverted for each of the pixels.

In the liquid crystal display unit in which such AC voltage driving is performed, as shown in FIG. 9 for example, in some case, a white image and a black image are alternately displayed for each of frames. In this case, a pixel voltage applied to pixels becomes a DC voltage Vdc as an effective value with respect to a common voltage Vcom. Therefore, when used for a long time, liquid crystal is deteriorated and display quality is deteriorated. As shown in FIG. 10A for example, in some case, a bright image 101 is displayed on a liquid crystal display unit 100 in a dark background on the basis of a signal of an interlaced system. In this case, in a region R1 in a boundary between the image 101 and the background, a white image and a black image are alternately displayed in an A field and a B field. Therefore, as shown in FIG. 10B, since a potential difference occurs in a pixel voltage in the boundary region R1 between the A field and the B field, an average voltage Vave deviates from 0. As a result, as shown in FIG. 10C, a residual image 102 occurs in the boundary region R1 between the image 101 and the background.

It is known that, in order to prevent the pixel voltage from becoming the DC voltage Vdc as an effective value, as shown in FIG. 11 for example, the phase of the polarity of a voltage applied to pixels is inverted for each plurality of frames. Consequently, biases on a positive electrode side and a negative electrode side of the pixel voltage with respect to the common voltage Vcom are reversed every time the phase is inverted. Therefore, it is possible to suppress the pixel voltage from becoming a DC voltage as an effective value.

However, as shown in FIG. 12 for example, when images having substantially fixed brightness are displayed, the luminance of the displayed images increases and a flicker occurs in the frame immediately after the phase inversion. As shown in FIG. 13 for example, when the phase inversion is not performed, a voltage having different polarity is always applied to the pixels for each of the frames. On the other hand, when the phase of the polarity of the pixel voltage is inverted for each plurality of frames, as shown in FIG. 12, a voltage having the same polarity is continuously applied to the pixels in the frame immediately before the phase inversion and the frame immediately after the phase inversion. When the voltage having the same polarity is continuously applied to the pixels, a response of the liquid crystal is improved compared with the other frames. Therefore, the luminance of the images increases in the frame immediately after the phase inversion. As a result, when the phase inversion is performed, there is an effect of preventing the DC voltage from being applied to the liquid crystal, whereas a flicker occurs as a side effect and the display quality of the images is deteriorated. Therefore, in the technology described in Japanese Patent Application Publication No. 2007-225861, a proposal for reducing a voltage applied to the pixels in the frame immediately after the phase inversion is made to thereby suppress the occurrence of a flicker and prevent the display quality of the images from being deteriorated.

However, the deterioration in the display quality of the images due to the flicker is affected by the temperature or variation in the liquid crystal display unit, and it is difficult to completely eliminate such deterioration. The deterioration in the display quality of the images due to the flicker is relatively less conspicuous in moving images such as images displayed on a television. However, the deterioration in the display quality of the images is conspicuous in cases where there are many still images and the screen is uniform such as with the images displayed on a personal computer (PC). Recently, cases or inputting these PC signals into a television are increasing, and it is necessary to inhibit the generation of flickers and prevent the deterioration in the display quality of images. On the other hand, since images displayed on PC screens and tablets were mainly based on progressive signals conventionally, this kind of phase inversion itself was not required. However, cases where interlaced signals are input via the internet are increasing. Thus, even with PC screens, it is necessary to prevent the deterioration in the display quality of images while preventing the generation of residual images caused by the application of a DC voltage to the pixels based on an interlaced signal.

### SUMMARY

In one general aspect, the instant application describes a liquid crystal display device includes: a liquid crystal display unit that includes pixels and displays an image based on an input image signal input for each of frames; a drive unit that applies a voltage based on the input image signal to the pixels of the liquid crystal display unit while inverting a polarity of the voltage for each of the frames; a signal discrimination unit that discriminates whether the input image signal is an interlaced signal; and a signal generation unit that generates a phase inversion enabling signal for inverting a phase of the polarity of the voltage applied to the pixels, in a case where the signal discrimination unit discriminates that the input image signal is the interlaced signal, wherein the drive unit inverts the phase of the polarity of the voltage applied to the pixels when the signal generation unit generates the phase inversion enabling signal.

In a case where the input image signal is discriminated as the interlaced signal, the phase of the polarity of the voltage applied to the pixels is inverted. Therefore, it is possible to prevent a DC voltage from being applied to the pixels for a long period to generate a residual image. As a result, it is possible to prevent deterioration in the display quality of images.

### BRIEF DESCRIPTION OF THE DRAWINGS

FIG. 1 is a block diagram showing a configuration of a liquid crystal display device according to a first embodiment of the instant application;

FIG. 2 is a block diagram showing a configuration of a signal discrimination circuit;

FIG. 3 is a diagram schematically showing a display screen of a liquid crystal display panel;

FIG. 4 is a timing chart schematically showing an operation example of the liquid crystal display device according to the first embodiment;

FIG. 5 is a block diagram showing a configuration of a liquid crystal display device according to a second embodiment of the instant application;

FIG. 6 is a block diagram showing the configuration of a signal discrimination circuit;

FIG. 7 is a diagram showing an example of an addition value set in advance to correspond to a difference value of a signal level between adjacent frames;

FIG. 8 is a diagram showing, in tabular form, an example of an operation in the second embodiment;

FIG. 9 is a diagram schematically showing pixel polarity and a pixel voltage in a case where a white image and a black image are alternately displayed for each of frames;

FIG. 10A is a diagram showing a liquid crystal display unit on which a bright image is displayed in a dark background on the basis of an interlaced signal, FIG. 10B is a diagram showing a pixel voltage in a boundary region between the image and the background, FIG. 10C is a diagram showing the liquid crystal display unit on which a residual image is generated in the boundary region between the image and the background;

FIG. 11 is a diagram schematically showing pixel polarity and a pixel voltage when phase inversion is performed, in a case where a white image and a black image are alternately displayed for each of the frames;

FIG. 12 is a diagram schematically showing pixel polarity and a pixel voltage when phase inversion is performed, in a case where an image having fixed luminance is displayed for each of the frames; and

FIG. 13 is a diagram schematically showing pixel polarity and a pixel voltage when phase inversion is not performed, in a case where an image having fixed luminance is displayed for each of the frames.

### DETAILED DESCRIPTION

### First Embodiment

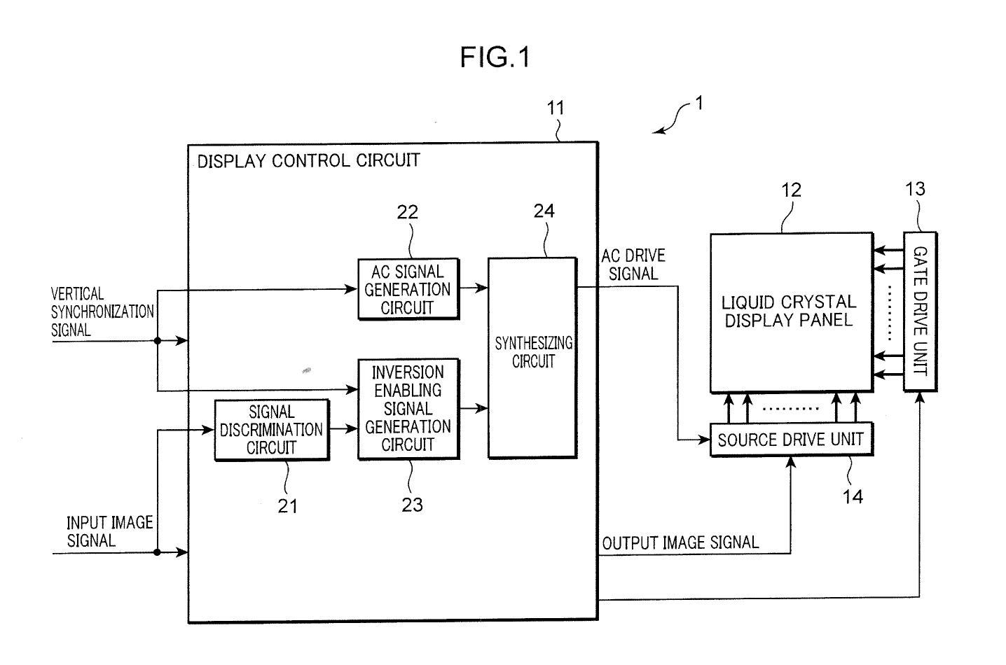

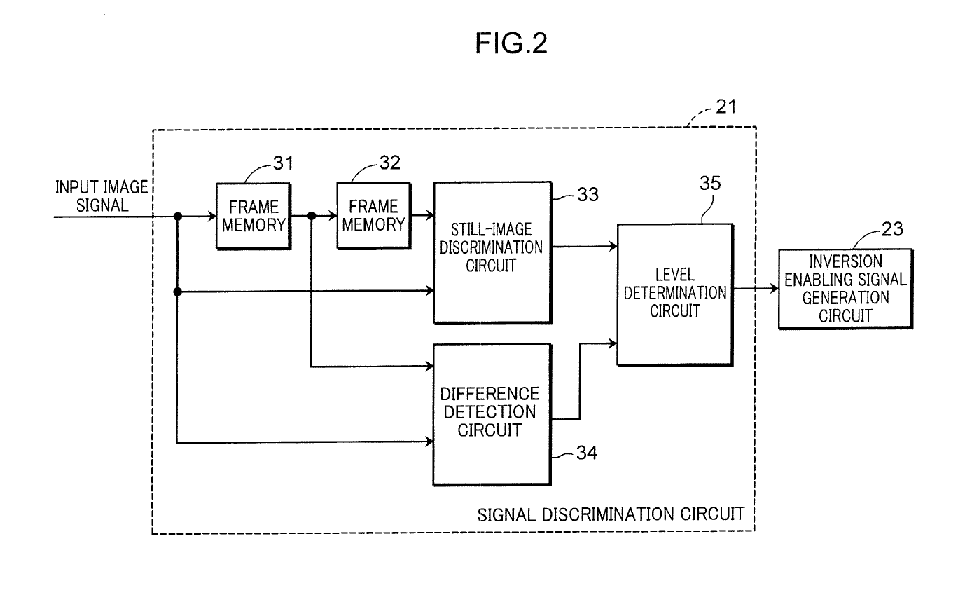

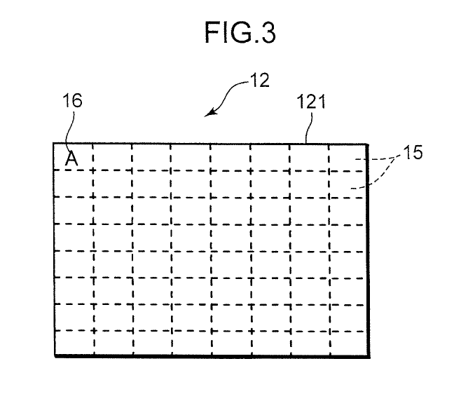

FIG. 1 is a block diagram showing a configuration of a liquid crystal display device according to a first embodiment of the instant application. FIG. 2 is a block diagram showing the configuration of a signal discrimination circuit. FIG. 3 is a diagram schematically showing a display screen of a liquid crystal display panel. As shown in FIG. 1, a liquid crystal display device 1 includes a display control circuit 11, a liquid crystal display panel 12, a gate drive unit 13, and a source drive unit 14.

The liquid crystal display panel 12 includes a plurality of gate signal lines, a plurality of source signal lines, and a plurality of pixels, all of which are not shown in the figure. The plurality of gate signal lines are provided to extend in the lateral direction (a main scanning direction) and provided side by side in the longitudinal direction (a sub-scanning direction). The plurality of source signal lines are provided to extend in the longitudinal direction (the sub-scanning direction) and provided side by side in the lateral direction (the main scanning direction). The plurality of pixels are arranged in a matrix at crossing points of the plurality of gate signal lines and the plurality of source signal lines.

The display control circuit 11 controls the gate drive unit 13 and the source drive unit 14 on the basis of an input image signal and a vertical synchronization signal to write, for each of frames, image data once in the pixels arranged in a matrix of the liquid crystal display panel 12. The gate drive unit 13 applies a scanning voltage to the gate signal lines to select the gate signal lines in order from the top to the bottom. The source drive unit 14 applies, via the source signal lines, a voltage corresponding to the image data to the pixels corresponding to the gate signal lines selected by the gate drive unit 13. Consequently, the voltage corresponding to the image data is applied to liquid crystal layers of the pixels and the transmittance of the pixels is controlled. The selection of the gate signal lines is completed by the gate drive unit 13 from the top to the bottom, whereby the image data is written in all the pixels once on the basis of the input image signal and the vertical synchronization signal. An image for one frame is generated by the writing of the image data in all the pixels. The liquid crystal display panel 12 is a display unit of a hold type that holds the written image data for one frame period until writing of the next image data.

Image generation for one frame is repeated at a predetermined frame frequency by the display control circuit 11, whereby an image displayed on the liquid crystal display panel 12 is viewed by a viewer. As the liquid crystal display panel 12, an in plane switching (IPS) system, a vertical alignment (VA) system, and any other systems may be applied.

The display control circuit 11 includes, as shown in FIG. 1, a signal discrimination circuit 21, an alternate-current (AC) signal generation circuit 22, an inversion enabling signal generation circuit 23, and a synthesizing circuit 24. The signal discrimination circuit 21 discriminates whether or not an input image signal is an interlaced signal. The signal discrimination circuit 21 includes, as shown in FIG. 2, frame memories 31 and 32, a still-image discrimination circuit 33, a difference detection circuit 34, and a level determination circuit 35.

The frame memory 31 delays the input image signal by one frame period. The frame memory 31 outputs the input image signal delayed by one frame period to the frame memory 32 and the difference detection circuit 34. The frame memory 32 delays the input image signal from the frame memory 31 by one frame period. The frame memory 32 outputs the input image signal delayed by one frame period to the still-image discrimination circuit 33. In other words, a signal obtained by delaying the input image signal by two frame periods is output from the frame memory 32 to the still-image discrimination circuit 33.

The still-image discrimination circuit 33 calculates a difference value (a second difference) between a signal level of an input image signal of the current frame and a signal level of the input image signal delayed by two frame periods and output from the frame memory 32. As shown in FIG. 3, the still-image discrimination circuit 33 divides a display screen 121 of the liquid crystal display panel 12 into a plurality of (8×8=64 in FIG. 3) predetermined regions 15 and calculates the difference value for each of the predetermined regions 15. In a case where the calculated difference value is equal to or smaller than a still image reference value set in advance, the still-image discrimination circuit 33 discriminates that the input image signal represents a still image. In a case where the calculated difference value exceeds the still image reference value, the still-image discrimination circuit 33 discriminates that the input image signal represents not a still image but a moving image. The still-image discrimination circuit 33 performs, for each of the predetermined regions 15, the discrimination concerning whether the input image signal represents a still image. The still-image discrimination circuit 33 outputs a discrimination result to the level determination circuit 35. The still image reference value only has to be set to a value with which it is discriminated that the input image signal represents a still image when the difference value calculated by the still-image discrimination circuit 33 is equal to or smaller than the still image reference value. When the input image signal is represented by 8 bits (0 to 255), the still image reference value may be set to, a value in a range of 0 to 5 for example, i.e., a value smaller than about 2% of a maximum value of a signal level. In order to surely discriminate that the input image signal represents a still image, the still image reference value may be set to 1, which is a minimum value exceeding 0, for example.

The still-image discrimination circuit 33 compares signal levels of the input image signal of the same pixels and calculates the difference value. In this case, the still-image discrimination circuit 33 may compare signal levels of all the pixels in the predetermined regions 15 of the display screen 121 of the liquid crystal display panel 12. Alternatively, the still-image discrimination circuit 33 may compare signal levels of a part of the pixels set in advance in the predetermined regions 15 of the display screen 121 of the liquid crystal display panel 12. In this embodiment, the still-image discrimination circuit 33 discriminates, on the basis of the difference value between the signal levels of the input image signal of the current frame and the frame preceding the current frame by two frames, whether the input image signal represents a still image. However, a method of still image discrimination is not limited to this. For example, the still-image discrimination circuit 33 may discriminate, on the basis of a difference value between signal levels of the input image signal of successive two frames, whether the input image signal represents a still image.

The difference detection circuit 34 calculates, for each of the predetermined regions 15, a difference value (a first difference) between a signal level of an input image signal of the current frame and a signal level of the input image signal delayed by one frame period and output from the frame memory 31. The difference detection circuit 34 detects, for example, a pixel of which the signal level is a maximum value in the input image signal delayed by one frame period. The difference detection circuit 34 calculates a signal level of a pixel same as the detected pixel having the maximum value in the input image signal of the current frame. The difference detection circuit 34 compares the maximum value of the signal level of the input image signal delayed by one frame period and the signal level of the pixel same as the pixel having the maximum value in the input image signal of the current frame, and calculates the difference value. The difference detection circuit 34 outputs the difference value calculated for each of the predetermined regions 15 to the level determination circuit 35.

The level determination circuit 35 determines, for each of the predetermined regions 15, whether the difference value calculated by the difference detection circuit 34 exceeds a difference reference value set in advance. When the level determination circuit 35 determines that the difference value calculated by the difference detection circuit 34 exceeds the difference reference value and the still-image discrimination circuit 33 discriminates that the input image signal represents a still image, the level determination circuit 35 determines that the input image signal is the interlaced signal, and outputs a residual image generation signal to the inversion enabling signal generation circuit 23. When a difference value between signal levels of the input image signal in adjacent frames is not zero (i.e., exceeds the difference reference value) although the input image signal represents a still image, this means that the input image signal is the interlaced signal. Therefore, it is possible to suitably determine, with the level determination circuit 35, whether the input image signal is the interlaced signal. The above difference reference value only has to be set to, for example, a value with which it is discriminated that a residual image tends to be generated for instance, when the difference value calculated by the difference detection circuit 34 exceeds the difference reference value. When the input image signal is represented by 8 bits (0 to 255), the difference reference value may be set to, for example, a value in a range of 80 to 128, i.e., a value in a range of about 30 to 50% of the maximum value of the signal level. In order to surely prevent generation of a residual image, the difference reference value may be set to, for example, 80 (i.e., a value of about 30% of the maximum value of the signal level). In this way, the difference reference value is set to the value with which it is discriminated that a residual image tends to be generated. Consequently, when a residual image tends to be generated, the level determination circuit 35 can determine that the input image signal is the interlaced signal.

A configuration for determining whether the input image signal is the interlaced signal is not limited to the configuration described above. Alternatively, for example, when the input image signal is a composite signal, Y/C separation for separating a luminance signal (Y) and a color signal (C) may be performed to determine whether the input image signal is the interlaced signal using the separated signals. Further alternatively, it may be determined whether the input image signal is the interlaced signal using other signal processing circuits.

In FIG. 1, the AC signal generation circuit 22 outputs an alternating-current (AC) signal, of which the polarity of an applied voltage is inverted for each of frames, for an AC voltage driving the pixels of the liquid crystal display panel 12. The inversion enabling signal generation circuit 23 counts time in which the residual image generation signal is continuously output from the level determination circuit 35 of the signal discrimination circuit 21. When the counted time reaches a value set in advance, the inversion enabling signal generation circuit 23 outputs a phase inversion enabling signal. The inversion enabling signal generation circuit 23 counts the time as the number of frames. When the counted number of frames reaches N (N=6 in the first embodiment, for example), the inversion enabling signal generation circuit 23 outputs the phase inversion enabling signal. The phase inversion enabling signal is a signal for inverting a phase in the polarity of an applied voltage to the pixels inverted for each of the frames. The synthesizing circuit 24 synthesizes the AC signal output from the AC signal generation circuit 22 and the phase inversion enabling signal output from the inversion enabling signal generation circuit 23 to generate an AC driving signal, and outputs the generated AC driving signal to the source drive unit 14.

The number of frames N is set to 6 in the first embodiment. However, the number of frames N is not limited to this. The number of frames N only has to be set taking into account prevention of an influence due to a malfunction and time until burn-in due to a residual image being generated. In this embodiment, the liquid crystal display panel 12 corresponds to an example of a liquid crystal display unit, the signal discrimination circuit 21 corresponds to an example of a signal discrimination unit, the inversion enabling signal generation circuit 23 corresponds to an example of a signal generation unit, and the source drive unit 14 corresponds to an example of a drive unit. In this embodiment, the still-image discrimination circuit 33 corresponds to an example of a still-image discrimination unit, and the difference detection circuit 34 corresponds to an example of a difference detection unit. In this embodiment, the difference value calculated by the difference detection circuit 34 corresponds to an example of a first difference and the difference reference value corresponds to an example of a first threshold value. In this embodiment, the difference value calculated by the still-image discrimination circuit 33 corresponds to an example of a second difference and the still image reference value corresponds to an example of a second threshold value. In this embodiment, the predetermined regions 15 correspond to an example of a part of regions.

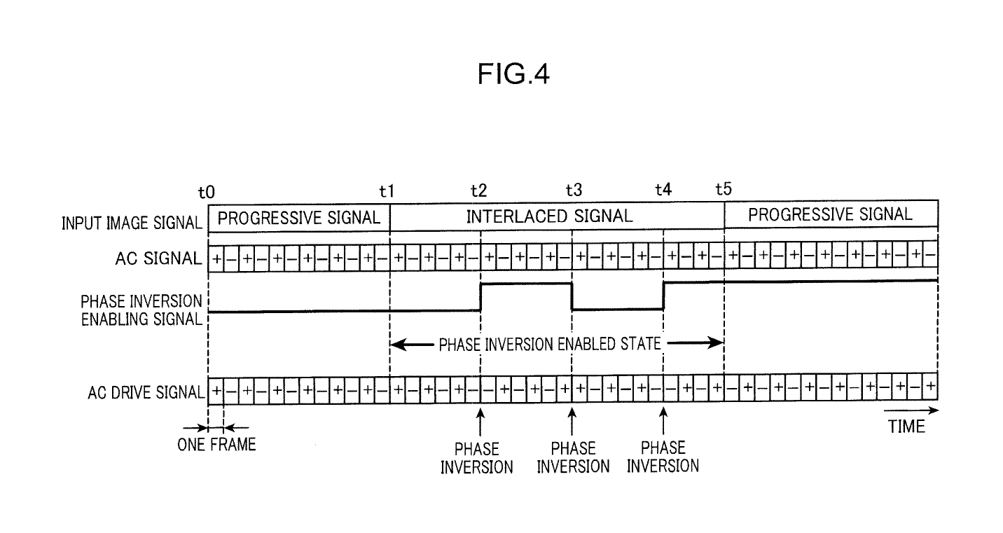

FIG. 4 is a timing chart schematically showing an operation example of the liquid crystal display device 1 according to the first embodiment. At time to, the operation of the liquid crystal display device 1 is started. A progressive signal is input as an input image signal from time t0. Therefore, the level determination circuit 35 of the signal discrimination circuit 21 determines that the input image signal is not the interlaced signal and does not output the residual image generation signal. As a result, the inversion enabling signal generation circuit 23 does not output the phase inversion enabling signal. Therefore, the synthesizing circuit 24 outputs an AC signal, which is output from the AC signal generation circuit 22, directly to the source drive unit 14 as an AC driving signal. The source drive unit 14 drives the pixels of the liquid crystal display panel 12 while inverting, on the basis of the AC driving signal, the polarity of an applied voltage to the pixels of the liquid crystal display panel 12 for each of the frames.

When the input image signal is switched from the progressive signal to the interlaced signal at time t1, the signal discrimination circuit 21 discriminates that the input image signal is the interlaced signal. Further, it is assumed here that the level determination circuit 35 determines that the difference value calculated by the difference detection circuit 34 exceeds the difference reference value. As a result, the inversion enabling signal generation circuit 23 starts counting of the number of frames in which a state (a phase inversion enabled state) continues in which the input image signal is the interlaced signal and the difference value calculated by the difference detection circuit 34 exceeds the difference reference value. When the counted number of frames reaches 6 (time t2), the inversion enabling signal generation circuit 23 outputs the phase inversion enabling signal. In the first embodiment, as shown in FIG. 4, inversion of a signal level between a low level signal and a high level signal is set as the phase inversion enabling signal.

When the phase inversion enabling signal is output from the inversion enabling signal generation circuit 23 at time t2, the synthesizing circuit 24 outputs, as the AC driving signal, a signal obtained by inverting the AC signal output from the AC signal generation circuit 22. As a result, at time t2, the phase of the polarity of the AC driving signal is inverted. Specifically, whereas the polarity of the AC driving signal in six frames from time t1 to time t2 is “+” “−”, “+”, “−”, “+”, and “−”, the polarity of the AC driving signal in six frames from time t2 to time t3 is “−”, “+”, “−”, “+”, “−”, and “+”. At time t2, the inversion enabling signal generation circuit 23 resets the count value of the number of frames, in which the phase inversion enabled state continues, to 0 and resumes the counting. As described above, the state of the polarity of the AC driving signal is inverted from “+”, “−”, . . . , to “−”, “+”, . . . . This inversion from“+”, “−”, . . . , to “−”, “+”, . . . , is called “the phase of the polarity of the AC driving signal is inverted”, or the “phase inversion” in this specification.

When the count value of the number of frames in which the phase inversion enabled state continues reaches 6 at time t3, the inversion enabling signal generation circuit 23 outputs the phase inversion enabling signal. Similarly, when the count value of the number of frames in which the phase inversion enabled state continues reaches 6 at time t4, the inversion enabling signal generation circuit 23 outputs the phase inversion enabling signal. As a result, the polarity of the AC driving signal in six frames from time t3 to time t4 is “+”, “−”, “+”, “−”, “+”, and “−” and the polarity of the AC driving signal from time t4 is “−”, “+”, “−”, and “+”.

When the input image signal is switched from the interlaced signal to the progressive signal at time t5 after four frames from time t4, the signal discrimination circuit 21 discriminates that the input image signal is not the interlaced signal. As a result, the inversion enabling signal generation circuit 23 resets the count value of the number of frames in which the phase inversion enabled state continues to 0 and stops the counting.

As described above, in the first embodiment, when it is determined that the input image signal is the interlaced signal, the phase inversion enabling signal is output and the phase of the polarity of the AC driving signal is inverted. Therefore, it is possible to suppress generation of a residual image and burn-in of an image. As a result, it is possible to prevent deterioration in the display quality of the image. In the first embodiment, the difference reference value is set to the value with which it is discriminated that a residual image tends to be generated. Therefore, when a residual image tends to be generated, the level determination circuit 35 can determine that the input image signal is the interlaced signal. Therefore, it is possible to suitably prevent generation of a residual image and burn-in of an image while reducing a frequency of occurrence of a flicker.

In the first embodiment, the inversion enabling signal generation circuit 23 outputs the phase inversion enabling signal when the state, in which the input image signal is the interlaced signal, continues by the number of plural frames N (N=6 in the first embodiment). If the number of frames is not counted and the phase inversion enabling signal is immediately output when it is determined that the input image signal is the interlaced signal, it is likely that an unnecessary phase inversion enabling signal is output because of a malfunction of the signal discrimination circuit 21. On the other hand, according to the first embodiment, the phase inversion enabling signal is output when the state continues by the number of frames N (N=6 in the first embodiment). Therefore, it is possible to prevent an influence due to the malfunction of the signal discrimination circuit 21 and surely output the phase inversion enabling signal when the input image signal is the interlaced signal. Even when the input image signal is switched to the interlaced signal, a residual image is not immediately generated and burn-in does not occur in the pixels. Therefore, even when the number of plural frames N is counted, no problem occurs.

In the first embodiment, the display screen 121 is divided into the predetermined regions 15, and when only one predetermined region 15 becomes a state in which a residual image tends to be generated (the difference value between the signal levels of the adjacent frames exceeds the difference reference value), it is determined that the input image signal is the interlaced signal, and the phase inversion enabling signal is output. Therefore, as shown in FIG. 3 for example, even when a character 16 (a character “A” in FIG. 3), which is a still image, is displayed in one predetermined region 15 and a moving image is displayed in the other predetermined regions 15, it is possible to surely prevent generation of a residual image and burn-in in this predetermined region 15.

In the first embodiment, when the level determination circuit 35 determines that the input image signal is the interlaced signal, the level determination circuit 35 outputs the residual image generation signal to the inversion enabling signal generation circuit 23. The inversion enabling signal generation circuit 23 counts time in which the residual image generation signal is continuously output, and when the counted time reaches a value set in advance, the inversion enabling signal generation circuit 23 outputs the phase inversion enabling signal. However, the present implementation is not limited to this. For example, the level determination circuit 35 may count a continuation time of a state in which the input image signal is determined as the interlaced signal, and when the counted time reaches a value set in advance, output the residual image generation signal to the inversion enabling signal generation circuit 23. When the residual image generation signal is output from the level determination circuit 35, the inversion enabling signal generation circuit 23 may immediately output the phase inversion enabling signal. In other words, when the counted time reaches the value set in advance, the level determination circuit 35 may determine that the input image signal is the interlaced signal. In this embodiment also, effects same as the effects in the first embodiment can be obtained.

### Second Embodiment

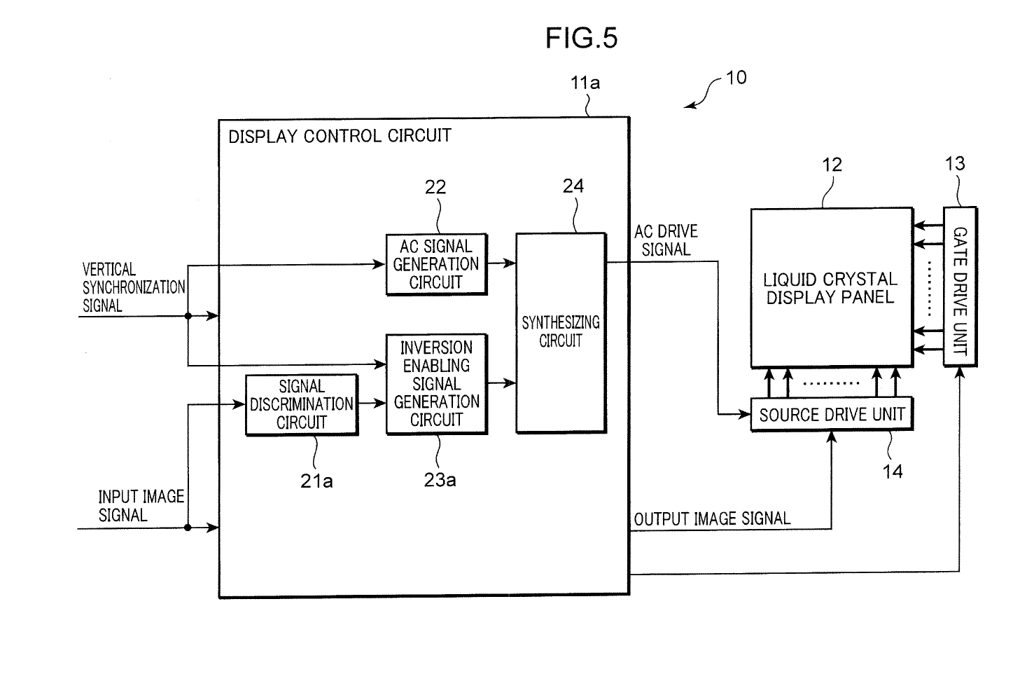

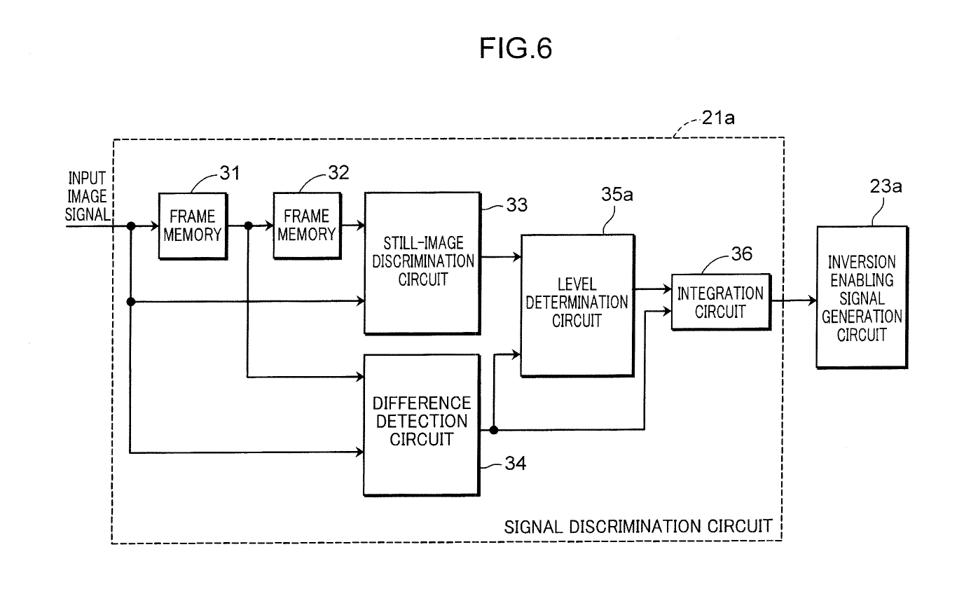

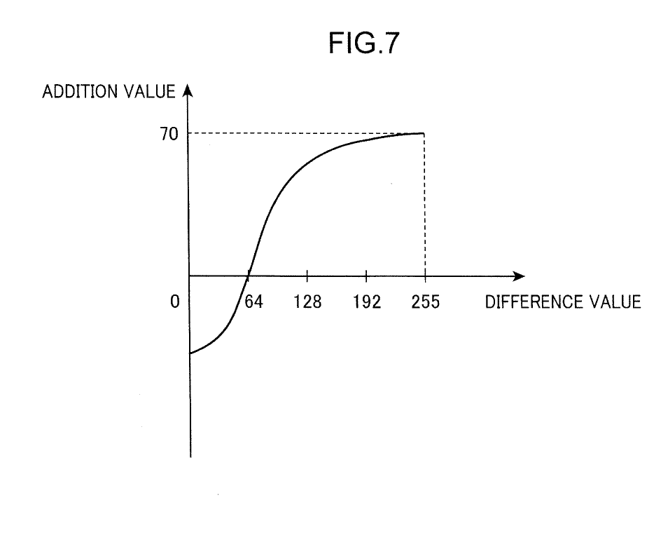

FIG. 5 is a block diagram showing a configuration of a liquid crystal display device 10 according to a second embodiment of the instant application. FIG. 6 is a block diagram showing a configuration of a signal discrimination circuit 21a. FIG. 7 is a diagram showing an example of an addition value set in advance to correspond to a difference value between signal levels in adjacent frames. In the second embodiment, components same as the components in the first embodiment are denoted by the same reference symbols. The second embodiment is described below centering on differences from the first embodiment.

The liquid crystal display device 10 according to the second embodiment shown in FIG. 5 includes a display control circuit 11a instead of the display control circuit 11, in the liquid crystal display device 1 according to the first embodiment shown in FIG. 1. The display control circuit 11a includes a signal discrimination circuit 21a instead of the signal discrimination circuit 21 and an inversion enabling signal generation circuit 23a instead of the inversion enabling signal generation circuit 23, in the display control circuit 11 shown in FIG. 1. The signal discrimination circuit 21a further includes an integration circuit 36 and includes a level determination circuit 35a instead of the level determination circuit 35, in the signal discrimination circuit 21 shown in FIG. 2.

The level determination circuit 35a determines, for each of the predetermined regions 15, whether the difference value calculated by the difference detection circuit 34 is zero. When the level determination circuit 35a determines that the difference value calculated by the difference detection circuit 34 is not zero and the still-image discrimination circuit 33 discriminates that the input image signal represents a still image, the level determination circuit 35a determines that the input image signal is the interlaced signal and outputs an interlace determination signal to the integration circuit 36. When there is a difference between the signal levels in the adjacent frames (i.e., the difference value is not zero) although the input image signal represents a still image, this means that the input image signal is the interlaced signal. Therefore, the level determination circuit 35a can suitably determine whether the input image signal is the interlaced signal.

The level determination circuit 35a determines whether the difference value calculated by the difference detection circuit 34 is zero. However, the determination of the difference value is not limited to this. When the input image signal is represented by 8 bits (0 to 255), the level determination circuit 35a may, for example, determine whether the difference value is equal to or smaller than 1. Specifically, when the level determination circuit 35a determines that the difference value calculated by the difference detection circuit 34 exceeds 1 and the still-image discrimination circuit 33 discriminates that the input image signal represents a sill image, the level determination circuit 35a may determine that the input image signal is the interlaced signal.

When the interlace determination signal is output from the level determination circuit 35a, the integration circuit 36 integrates an addition value set in advance to correspond to the difference value calculated by the difference detection circuit 34. The integration circuit 36 outputs an integrated value obtained by integrating the addition value to the inversion enabling signal generation circuit 23a. When the interlace determination signal is not output from the level determination circuit 35a, the integration circuit 36 sets the integrated value to zero.

As shown in FIG. 7, for example, the addition value is set to a negative value when the difference value is smaller than 64, sharply increases when the difference value is equal to or larger than 64 and thereafter gently increases, and is set to 70 when the difference value is 255. In the second embodiment, it is assumed that the input image signal is represented by 8 bits (0 to 255).

When the integrated value output from the integration circuit 36 becomes equal to or larger than an integration upper limit value TH1 set in advance (TH1=160 in the second embodiment, for example), the inversion enabling signal generation circuit 23a determines that the state is in a phase inversion enabled state, and outputs the phase inversion enabling signal for each of the predetermined number of frames N (N=6 in the second embodiment, for example). When the integrated value output from the integration circuit 36 becomes smaller than an integration lower limit value TH2 set in advance (TH2=128 in the second embodiment, for example), the inversion enabling signal generation circuit 23a determines that the state is not in the phase inversion enabled state and stops the output of the phase inversion enabling signal.

In the second embodiment, the integration upper limit value TH1 is set to 160. However, the integration upper limit value TH1 is not limited to this. The integration upper limit value TH1 only has to be set to an appropriate value, according to the addition value set to correspond to the difference value shown in FIG. 7, for example, a value corresponding to the predetermined number of frames N in the first embodiment. In other words, the integration upper limit value TH1 only has to be set taking into account prevention of an influence due to a malfunction of the signal discrimination circuit 21a and time until burn-in occurs due to a residual image. In this embodiment, the liquid crystal display panel 12 corresponds to an example of a liquid crystal display unit, the signal discrimination circuit 21a corresponds to an example of a signal discrimination unit, the inversion enabling signal generation circuit 23a corresponds to an example of a signal generation unit, and the source drive unit 14 corresponds to an example of a drive unit. In this embodiment, the still-image discrimination circuit 33 corresponds to an example of a still-image discrimination unit, the difference detection circuit 34 corresponds to an example of a difference detection unit, the integration circuit 36 corresponds to an example of an integration unit, the addition value corresponds to an example of a set value, and the integration upper limit value corresponds to a third threshold value. In this embodiment, the predetermined region 15 correspond to an example of a part of a region.

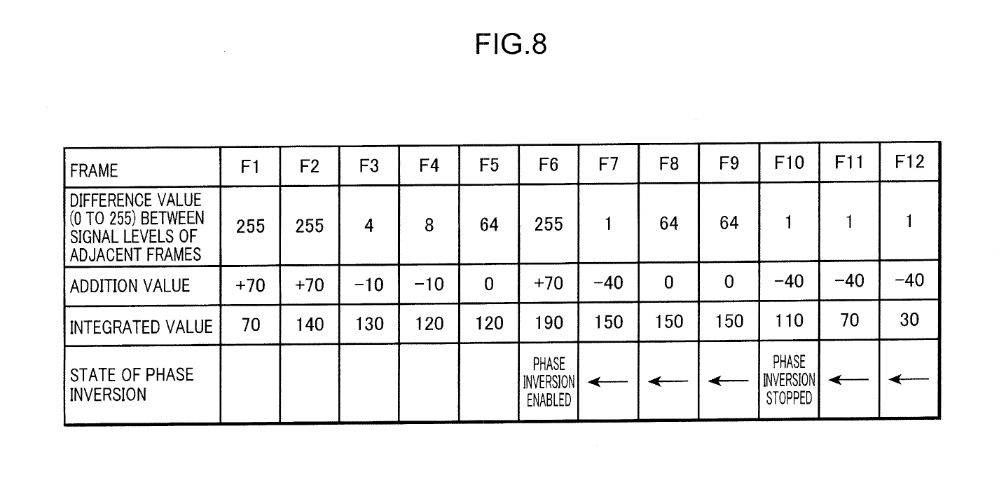

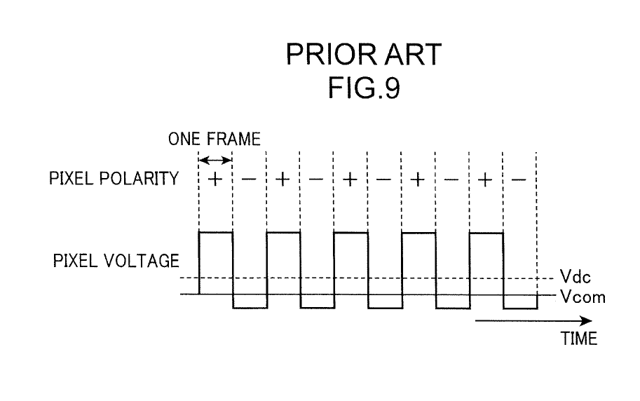

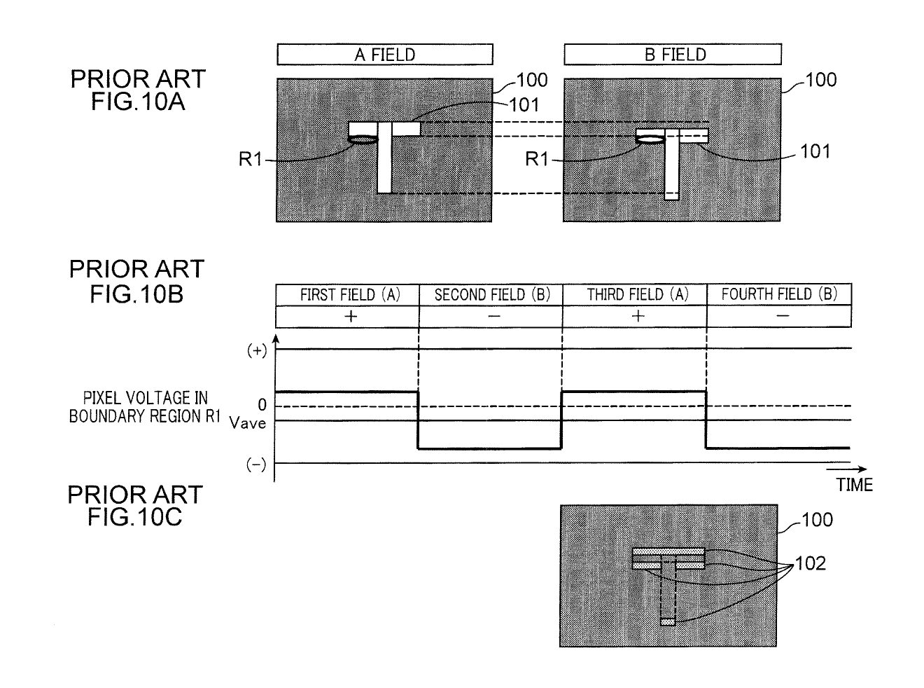

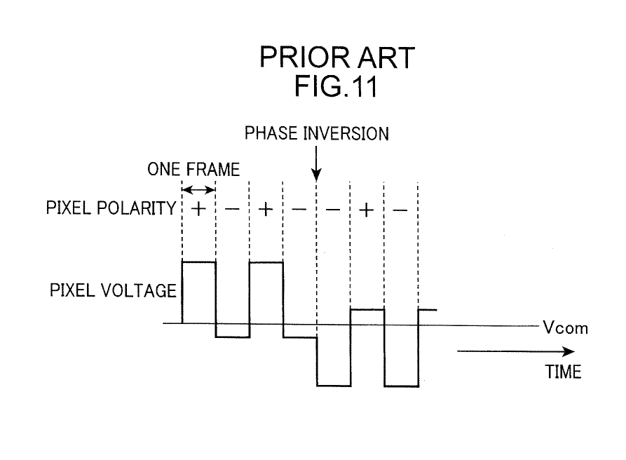

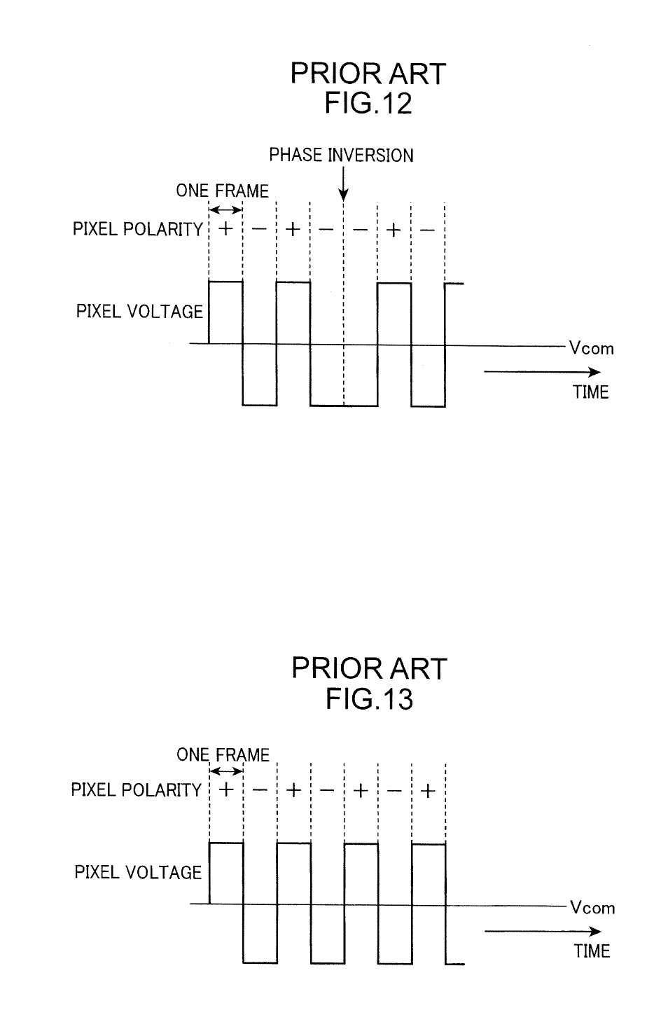

FIG. 8 is a diagram showing, in tabular form, an example of an operation in the second embodiment. In FIG. 8, in both of the frames F1 and F2, the difference value with respect to the previous frame is 255 and the addition value in the integration circuit 36 is set to “+70”. Therefore, the integrated value obtained by the integration circuit 36 is 70 and 140. In the following frames F3 to F5, the difference value decreases to 4, 8, and 64 and the addition value is set to “−10”, “−10”, and “0”. Therefore, the integrated value obtained by the integration circuit 36 is 130, 120, and 120.

In the following frame F6, the difference value is 255 and the addition value is set to “+70”. Therefore, the integrated value obtained by the integration circuit 36 is 190. Therefore, since the integrated value is equal to or larger than the integration upper limit value TH1=160, the inversion enabling signal generation circuit 23a determines that the state is in the phase inversion enabled state, and outputs the phase inversion enabling signal.

In the following frames F7 to F9, the difference value is 1, 64 and 64, and the addition value is set to “−40”, “0” and “0”. Therefore, the integrated value obtained by the integration circuit 36 is 150, 150 and 150. Therefore, since the integrated value is maintained equal to or larger than the integration lower limit value TH2=128, the inversion enabling signal generation circuit 23a determines that the state remains in the phase inversion enabled state.

In the following frame F10, the difference value is 1 and the addition value is set to “−40”. Therefore, the integrated value obtained by the integration circuit 36 is 110. Therefore, since the integrated value is smaller than the integration lower limit value TH2=128, the inversion enabling signal generation circuit 23a determines that the state is not in the phase inversion enabled state, and stops the output of the phase inversion enabling signal. The phase inversion enabled state ends after the four frames F6 to F9 and the count value of the number of frames does not reach 6. Therefore, the phase inversion enabling signal is not output after the frame F6.

In the following frames F11 and F12, the difference value is 1 and 1 and the addition value is set to “−40” and “−40”. Therefore, the integrated value obtained by the integration circuit 36 is 70 and 30. Therefore, since the integrated value is maintained smaller than the integration lower limit value TH2=128, the inversion enabling signal generation circuit 23a determines that the state remains in the phase inversion stopped state.

As described above, in the second embodiment, the addition value set in advance to correspond to the difference value between the signal levels of the adjacent frames is integrated, and when the input image signal is the interlaced signal and the integrated value becomes equal to or larger than the integration upper limit value TH1, it is determined that the state is in the phase inversion enabled state, and the phase inversion enabling signal is output. Therefore, when the input image signal is the interlaced signal and a residual image surely tends to be generated, the phase of the polarity of the voltage applied to the pixels is inverted. In this way, the phase of the polarity of the applied voltage to the pixels is inverted only when necessary. Therefore, it is possible to suitably prevent generation of a residual image and burn-in of an image while preventing occurrence of a flicker as much as possible. As a result, it is possible to prevent deterioration in the display quality of the image.

In the second embodiment, when the level determination circuit 35a determines that the input image signal is the interlaced signal, the level determination circuit 35a outputs the interlace determination signal to the integration circuit 36. When the interlace determination signal is output from the level determination circuit 35a, the integration circuit 36 integrates the addition value set in advance and outputs the integrated value to the inversion enabling signal generation circuit 23a. The inversion enabling signal generation circuit 23a outputs a phase inversion enabling signal when the integrated value output from the integration circuit 36 is equal to or larger than the integration upper limit value TH1. However, the present implementation is not limited to this and may be configured as described below. The integration circuit 36 integrates the addition value set in advance to correspond to the difference value calculated by the difference detection circuit 34. When the integrated value integrated by the integration circuit 36 is equal to or larger than the integration upper limit value TH1 while a state continues in which the still-image discrimination circuit 33 discriminates that the input image signal represents a sill image, the signal discrimination circuit 21a discriminates that the input image signal is the interlaced signal and outputs the interlace determination signal to the inversion enabling signal generation circuit 23a. When the interlace determination signal is output from the signal discrimination circuit 21a, the inversion enabling signal generation circuit 23a immediately outputs the phase inversion enabling signal. In this embodiment also, effects same as the effects in the second embodiment can be obtained.

(Others)

In the above first embodiment, the inversion enabling signal generation circuit 23 outputs the phase inversion enabling signal when the difference value calculated by the difference detection circuit 34 exceeds the difference reference value. However, in this case, the difference reference value may be set to zero. In other words, the inversion enabling signal generation circuit 23 may output the phase inversion enabling signal when it is determined that the input image signal is the interlaced signal. In this embodiment, the level determination circuit 35 sets the difference reference value to zero and determines whether the difference value calculated by the difference detection circuit 34 exceeds zero. When the level determination circuit 35 determines that the difference value calculated by the difference detection circuit 34 exceeds zero and the still-image discrimination circuit 33 discriminates that the input image signal represents a still image, the level determination circuit 35 determines that the input image signal is the interlaced signal. When the level determination circuit 35 determines that the input image signal is the interlaced signal, the level determination circuit 35 outputs the interlace determination signal to the inversion enabling signal generation circuit 23. When the interlace determination signal is output from the level determination circuit 35, the inversion enabling signal generation circuit 23 outputs the phase inversion enabling signal. In this embodiment, when it is determined that the input image signal is the interlaced signal, the phase inversion enabling signal is output and the phase of the polarity of the applied voltage to the pixels is inverted. Therefore, it is possible to prevent generation of a residual image.

In the above first embodiment, the display screen 121 of the liquid crystal display panel 12 is divided into the plurality of predetermined regions 15, and it is determined, for each of the predetermined regions 15, whether the input image signal is the interlaced signal, but this is not limiting. Alternatively, for example, it may be determined in the entire display screen 121 of the liquid crystal display panel 12 whether the input image signal is the interlaced signal.

The specific embodiments described above mainly include the liquid crystal display device configured as described below.

In one general aspect, the instant application describes a liquid crystal display device includes: a liquid crystal display unit that includes pixels and displays an image based on an input image signal input for each of frames; a drive unit that applies a voltage based on the input image signal to the pixels of the liquid crystal display unit while inverting a polarity of the voltage for each of the frames; a signal discrimination unit that discriminates whether the input image signal is an interlaced signal; and a signal generation unit that generates a phase inversion enabling signal for inverting a phase of the polarity of the voltage applied to the pixels, in a case where the signal discrimination unit discriminates that the input image signal is the interlaced signal, wherein the drive unit inverts the phase of the polarity of the voltage applied to the pixels when the signal generation unit generates the phase inversion enabling signal.

According to this configuration, the liquid crystal display unit includes the pixels and displays the image based on the input image signal input for each of the frames. The drive unit applies the voltage based on the input image signal to the pixels of the liquid crystal display unit while inverting the polarity of the voltage for each of the frames. The signal discrimination unit discriminates whether the input image signal is the interlaced signal. The signal generation unit generates the phase inversion enabling signal for inverting the phase of the polarity of the voltage applied to the pixels, in a case where the signal discrimination unit discriminates that the input image signal is the interlaced signal. The drive unit inverts the phase of the polarity of the voltage applied to the pixels when the signal generation unit generates the phase inversion enabling signal.

When the input image signal is the interlaced signal, if the polarity of the voltage applied to the pixels is inverted for each of the frames, a DC voltage is easily applied to the pixels. When the DC voltage is applied to the pixels for a long time, a residual image is generated and, as a result, display quality is deteriorated. On the other hand, with the configuration described above, when it is discriminated that the input image signal is the interlaced signal, the phase of the polarity of the voltage applied to the pixels is inverted. Therefore, since the DC voltage is not applied to the pixels for a long time, it is possible to suppress generation of a residual image. As a result, it is possible to prevent deterioration in the display quality of an image.

The above general aspect may include one or more of the following features. The signal discrimination unit may discriminate whether the input image signal, which is used for display of a part of a display region for the image of the liquid crystal display unit, is the interlaced signal.

According to this configuration, the signal discrimination unit discriminates whether the input image signal, which is used for the display of a part of the display region for the image of the liquid crystal display unit, is the interlaced signal. Depending on a displayed image, when the input image signal is the interlaced signal, the DC voltage tends to be applied to the pixels in a part of the display region for the image of the liquid crystal display unit. Therefore, in the case of such an image, it is possible to suitably prevent generation of a residual image.

The signal discrimination unit may include: a still-image discrimination unit that discriminates whether an image displayed on the liquid crystal display unit is a still image, using the input image signal of each of a predetermined plurality of the frames; and a difference detection unit that detects a first difference, which is a difference between the input image signal of a predetermined frame and the input image signal of a frame displayed on the liquid crystal display unit immediately preceding the predetermined frame, and the signal discrimination unit discriminates that the input image signal is the interlaced signal, in a case where the still-image discrimination unit discriminates that the input image signal represents a still image and the first difference detected by the difference detection unit exceeds a first threshold value set in advance.

According to this configuration, the still-image discrimination unit discriminates whether the image displayed on the liquid crystal display unit is a still image, using the input image signal of each of the predetermined plurality of frames. The difference detection unit detects the first difference, which is the difference between the input image signal of the predetermined frame and the input image signal of the frame displayed on the liquid crystal display unit immediately preceding the predetermined frame. The signal discrimination unit discriminates that the input image signal is the interlaced signal, in a case where the still-image discrimination unit discriminates that the input image signal represents a still image and the first difference detected by the difference detection unit exceeds the first threshold value set in advance. In a case where the input image signal represents a still image, the first difference, which is the difference between the input image signals of the adjacent frames, is usually considered to be zero. However, when the first difference exceeds the first threshold value, this means that the input image signal is the interlaced signal. Therefore, with the configuration described above, it is possible to suitably discriminate the interlaced signal.

A frame displayed on the liquid crystal display unit immediately preceding the predetermined frame is defined as a first frame, a frame displayed on the liquid crystal display unit immediately preceding the first frame is defined as a second frame, the still-image discrimination unit discriminates whether a second difference, which is a difference between the input image signal of the predetermined frame and the input image signal of the second frame, is equal to or smaller than a second threshold value set in advance, and the second threshold value is set to a value with which it is determined that the input image signal represents a still image when the second difference is equal to or smaller than the second threshold value.

According to this configuration, the frame displayed on the liquid crystal display unit immediately preceding the predetermined frame is defined as the first frame. The frame displayed on the liquid crystal display unit immediately preceding the first frame is defined as the second frame. The still-image discrimination unit discriminates whether the second difference, which is the difference between the input image signal of the predetermined frame and the input image signal of the second frame, is equal to or smaller than the second threshold value set in advance. The second threshold value is set to the value with which it is discriminated that the input image represents a still image when the second difference is equal to or smaller than the second threshold value. Therefore, when the still-image discrimination unit discriminates that the second difference is equal to or smaller than the second threshold value, it is possible to suitably discriminate that the input image signal represents a still image.

The still-image discrimination unit may discriminate whether the second difference is equal to or smaller than the second threshold value in a part of a display region for the image of the liquid crystal display unit, the difference detection unit detects the first difference for each of the pixels; and the signal discrimination unit discriminates that the input image signal is the interlaced signal, in a case where the still-image discrimination unit discriminates that the second difference is equal to or smaller than the second threshold value in the part of the display region and the first difference detected by the difference detection unit in at least one of the pixels included in the part of the display region exceeds the first threshold value.

According to this configuration, the still-image discrimination unit discriminates whether the second difference is equal to or smaller than the second threshold value in a part of the display region for the image of the liquid crystal display unit. The difference detection unit detects the first difference for each of the pixels. The signal discrimination unit discriminates that the input image signal is the interlaced signal, in a case where the still-image discrimination unit discriminates that the second difference is equal to or smaller than the second threshold value in the part of the display region and the first difference detected by the difference detection unit in at least one of the pixels included in the part of the display region exceeds the first threshold value.

Depending on a displayed image, a still image is displayed only in a part of the display region for the image of the liquid crystal display unit. Therefore, when the input image signal is the interlaced signal, the DC voltage tends to be applied to the pixels in the region. Therefore, in the case of such an image, it is possible to suitably prevent generation of a residual image.

The signal discrimination unit may discriminate that the input image signal is the interlaced signal, in a case where the still-image discrimination unit discriminates that the second difference is equal to or smaller than the second threshold value in the part of the display region and a state, in which the first difference detected by the difference detection unit in at least one of the pixels included in the part of the display region exceeds the first threshold value, continues for a predetermined time.

According to this configuration, when it is discriminated that the second difference is equal to or smaller than the second threshold value in the part of the display region by the still-image discrimination unit and a state, in which the first difference detected by the difference detection unit in at least one of the pixels included in the part of the display region exceeds the first threshold value, continues for a predetermined time, the signal discrimination unit discriminates that the input image signal is the interlaced signal. Therefore, when the input image interlaced signal continues to be displayed for a predetermined period, it is possible to more surely prevent deterioration in display quality. Further, it is possible to more surely prevent a wrong determination that the progressive signal is the interlaced signal.

The signal discrimination unit may further include an integration unit that integrates, for each of the frames, a set value set in advance to correspond to the first difference detected by the difference detection unit, and the signal discrimination unit may discriminate that the input image signal is the interlaced signal, when an integrated value of the set value integrated by the integration unit is equal to or larger than a third threshold value set in advance while a state continues in which the still-image discrimination unit discriminates that the second difference is equal to or smaller than the second threshold value.

According to this configuration, the integration unit integrates, for each of the frames, the set value set in advance to correspond to the first difference detected by the difference detection unit. When the integrated value of the set value integrated by the integration unit is equal to or larger than the third threshold value set in advance while the state continues in which the still-image discrimination unit discriminates that the second difference is equal to or smaller than the second threshold value, the signal discrimination unit discriminates that the input image signal is the interlaced signal. When the input image interlaced signal tends to generate a residual image, it is possible to more surely prevent deterioration in display quality. Further, it is possible to more surely prevent a wrong determination that the progressive signal is the interlaced signal.

### INDUSTRIAL APPLICABILITY

The liquid crystal display device that displays an image corresponding to an input image signal on a liquid crystal display unit is useful as a liquid crystal display device that can prevent deterioration of the display quality of the image while preventing generation of a residual image.

This application is based on Japanese Patent application No. 2011-288297 filed in Japan Patent Office on Dec. 28, 2011, the contents of which are hereby incorporated by reference.

Although the present application has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A liquid crystal display device comprising:
a liquid crystal display unit that includes pixels and displays an image based on an input image signal input for each of frames;
a drive unit that applies a voltage based on the input image signal to the pixels of the liquid crystal display unit while inverting a polarity of the voltage for each of the frames;
a signal discrimination unit that discriminates whether the input image signal is an interlaced signal; and
a signal generation unit that generates a phase inversion enabling signal for inverting a phase of the polarity of the voltage applied to the pixels, in a case where the signal discrimination unit discriminates that the input image signal is the interlaced signal, wherein
the drive unit inverts the phase of the polarity of the voltage applied to the pixels when the signal generation unit generates the phase inversion enabling signal.

2. The liquid crystal display device according to claim 1, wherein the signal discrimination unit discriminates whether the input image signal, which is used for display of a part of a display region for the image of the liquid crystal display unit, is the interlaced signal.

3. The liquid crystal display device according to claim 1, wherein
the signal discrimination unit includes:
a still-image discrimination unit that discriminates whether an image displayed on the liquid crystal display unit is a still image, using the input image signal of each of a predetermined plurality of the frames; and
a difference detection unit that detects a first difference, which is a difference between the input image signal of a predetermined frame and the input image signal of a frame displayed on the liquid crystal display unit immediately preceding the predetermined frame, and
the signal discrimination unit discriminates that the input image signal is the interlaced signal, in a case where the still-image discrimination unit discriminates that the input image signal represents a still image and the first difference detected by the difference detection unit exceeds a first threshold value set in advance.

4. The liquid crystal display device according to claim 3, wherein
a frame displayed on the liquid crystal display unit immediately preceding the predetermined frame is defined as a first frame,
a frame displayed on the liquid crystal display unit immediately preceding the first frame is defined as a second frame,
the still-image discrimination unit discriminates whether a second difference, which is a difference between the input image signal of the predetermined frame and the input image signal of the second frame, is equal to or smaller than a second threshold value set in advance, and
the second threshold value is set to a value with which it is determined that the input image signal represents a still image when the second difference is equal to or smaller than the second threshold value.

5. The liquid crystal display device according to claim 4, wherein
the still-image discrimination unit discriminates whether the second difference is equal to or smaller than the second threshold value in a part of a display region for the image of the liquid crystal display unit,
the difference detection unit detects the first difference for each of the pixels; and
the signal discrimination unit discriminates that the input image signal is the interlaced signal, in a case where the still-image discrimination unit discriminates that the second difference is equal to or smaller than the second threshold value in the part of the display region and the first difference detected by the difference detection unit in at least one of the pixels included in the part of the display region exceeds the first threshold value.

6. The liquid crystal display device according to claim 5, wherein the signal discrimination unit discriminates that the input image signal is the interlaced signal, in a case where the still-image discrimination unit discriminates that the second difference is equal to or smaller than the second threshold value in the part of the display region and a state, in which the first difference detected by the difference detection unit in at least one of the pixels included in the part of the display region exceeds the first threshold value, continues for a predetermined time.

7. The liquid crystal display device according to claim 4, wherein
the signal discrimination unit further includes an integration unit that integrates, for each of the frames, a set value set in advance to correspond to the first difference detected by the difference detection unit, and
the signal discrimination unit discriminates that the input image signal is the interlaced signal, when an integrated value of the set value integrated by the integration unit is equal to or larger than a third threshold value set in advance while a state continues in which the still-image discrimination unit discriminates that the second difference is equal to or smaller than the second threshold value.
